(19) United States
(12) Patent Application Publication
(10) Pub. No.: US 2026/0025486 A1
(43) Pub. Date: Jan. 22, 2026

(54) METHOD AND SYSTEM FOR MONITORING A SAFETY AREA

(71) Applicant: TRUMPF Werkzeugmaschinen SE + Co. KG, Ditzingen (DE)

(72) Inventors: Thorsten Larsen-Vefring, Stuttgart (DE); Klaus Bauer, Ditzingen (DE); Marcel Ely Gomes, Stuttgart (DE); Zaigham Faraz Siddiqui, Böblingen (DE)

(21) Appl. No.: 19/339,364

(22) Filed: Sep. 25, 2025

Related U.S. Application Data
(63) Continuation of application No. PCT/EP2024/057784, filed on Mar. 22, 2024.

(30) Foreign Application Priority Data
Mar. 28, 2023 (DE) 10 2023 107 857.7

(51) Int. Cl. H04N 7/18; G06V 20/40; G06V 20/52; G08B 21/02

(52) U.S. Cl. CPC H04N 7/188; G06V 20/46; G06V 20/52; G08B 21/02; H04N 7/183; G06V 2201/06

(57) ABSTRACT

A method for monitoring a safety area of a machine tool, wherein the safety area has at least one access area and access to the safety area is only possible via the access area, the method including monitoring the access area is at least by a camera and a further sensor, connecting the camera and the further sensor to a computer system, and monitoring with the computer system, by the further sensor, whether an object enters the safety area. The method further includes capturing with the camera at least one image of the access area when the computer system detects by the further sensor that the object is entering the safety area and evaluating the at least one image captured by the camera with the computer system after it has been established by the further sensor that the object has entered the safety area.

### CROSS REFERENCE TO RELATED APPLICATIONS

This application is a continuation of International Application No. PCT/EP2024/057784 (WO 2024/200275 A1), filed on Mar. 22, 2024, and claims benefit to German Patent Application No. DE 10 2023 107 857.7, filed on Mar. 28, 2023. The aforementioned applications are hereby incorporated by reference herein.

### FIELD

The invention relates to a method for monitoring a safety area and to a system for monitoring a safety area.

### BACKGROUND

DE 10 2009 36641 A1 describes a safety device for securing a room area that can only be accessed via a secure access lock.

### SUMMARY

In an embodiment, the present disclosure provides a method for monitoring a safety area of a machine tool, wherein the safety area has at least one access area and access to the safety area is only possible via the access area, the method comprising monitoring the access area is at least by a camera and a further sensor, connecting the camera and the further sensor to a computer system, and monitoring with the computer system, by the further sensor, whether an object enters the safety area. The method further comprises capturing with the camera at least one image of the access area when the computer system detects by the further sensor that the object is entering the safety area and evaluating the at least one image captured by the camera with the computer system after it has been established by the further sensor that the object has entered the safety area.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a system comprising a safety area with an access area;

FIG. 2 shows a system comprising a safety area with two access areas; and

FIG. 3 shows an exemplary method according to an embodiment of the present disclosure.

### DETAILED DESCRIPTION

In an embodiment, the present disclosure provides a method and a system which further improve upon the prior art.

The present disclosure comprises a method for monitoring a safety area, in particular of a machine tool, wherein the safety area has at least one access area and access to the safety area is only possible via the access area, wherein the access area is monitored at least by a camera and a further sensor, wherein the camera and the further sensor are connected to a computer system, wherein the computer system monitors by means of the further sensor whether an object enters the safety area, wherein the camera captures at least one image of the access area when the computer system detects by means of the further sensor that an object is entering the safety area, wherein the image recorded by the camera is only evaluated by the computer system after it has been established by means of the further sensor that an object has entered the safety area.

The entry of an object into the safety area is therefore first established by the further sensor. Only then is the image from the camera evaluated. This evaluation of the image requires complex arithmetic operations. The fact that the image is only evaluated when necessary, namely when the further sensor has established that an object has entered the safety area, increases the efficiency of the method.

In particular, the machine tool can be a laser cutting machine, a laser welding machine, a punching machine or a bending machine. Lasers and parts of the machine tool that move with great force pose a hazard that can potentially harm people or objects in the safety area. On the other hand, objects in the safety area can pose a hazard to the often complex and therefore valuable machine tool.

The safety area is preferably secured when it has been established by means of the further sensor that an object has entered the safety area. Securing the safety area means that sources of hazards in the safety area are switched off. In the case of a safety area of a machine tool, for example, the machine tool is brought into a safe operating state, e.g. by stopping the machine tool. The fact that the safety area is secured when it has been established by means of the further sensor that an object has entered the safety area means that the safety area is secured particularly quickly. The system does not wait until the image recorded by the camera has been evaluated.

Preferably, the camera records images repeatedly, in particular at regular intervals, in particular in the form of a video. By recording multiple images, a chronological course of the conditions in the access area can be reconstructed.

Preferably, the images recorded by the camera are stored in a memory, in particular a ring memory, for at least one second, preferably 2 seconds, particularly preferably 5 seconds. By storing the images, once it has been established by the further sensor that an object has entered the safety area, the entry of the object into the safety area can be reconstructed and/or verified in the images.

In an embodiment, the camera continuously records images, in particular videos. By storing the images for a longer period of time and in particular by using a ring memory, the conditions in the access area before the object enters can also be determined in the images.

In an embodiment, the camera only starts to record one or more images after it has been established by means of the further sensor that an object has entered the safety area. The fact that the camera only records images when required means that energy can be saved. Preferably, the camera starts recording within one second, particularly preferably within half a second, after it has been established by means of the further sensor that an object has entered the safety area.

The camera preferably, at least after it has been established by means of the further sensor that an object has entered the safety area, continuously records images. The continuous recording allows the conditions in the safety area to be reconstructed after the object has entered.

Preferably, the computer system automatically evaluates one or more images recorded by the camera, preferably by means of artificial intelligence, and automatically releases the safety area if the evaluation shows that the safety area is secure. Due to the automated evaluation, the safety area is released again very quickly. For example, the machine tool can resume work very quickly. The automated evaluation is particularly advantageous if the evaluation of the images establishes that the object has triggered the further sensor but has left the safety area again immediately.

Preferably, the computer system examines multiple consecutive images for at least one moving object. By examining the images for a moving object, the evaluation of the images can be accelerated, as only moving objects can enter the safety area.

Particularly preferably, the computer system determines a direction of movement of the moved object, in particular whether the direction of movement of the moved object is directed into the safety area or out of the safety area. By determining the direction of movement, the hazard posed by the object can be better assessed. Typically, an object that moves into the safety area poses a greater hazard than an object that moves out of the safety area. In particular, the computer system can determine that an object has first moved into the safety area and then out again. In this case, the hazard was only temporary and the safety area can be released again.

Preferably, the computer system outputs at least one image for releasing the safety area by an operator and optionally outputs a warning signal to the operator. The operator can use the image to assess the situation in the hazard area and release the safety area, if appropriate. If there is a permanent hazard, the operator can initiate countermeasures. The warning signal informs the operator that it has been established by means of the further sensor that an object has entered the safety area and that the operator should evaluate the image. The warning signal can be visual, e.g. a flashing light, acoustic, e.g. a warning tone, and/or haptic, e.g. a vibration alarm from a mobile device carried by the operator.

Particularly preferably, the computer system outputs to the operator at least one image, in particular a video, which was recorded by the camera shortly after it was established by means of the further sensor that an object has entered the safety area, and at least one further image, in particular a current video transmission, which represents the current conditions. The operator can use the two outputs to assess both what the situation was when it was established by means of the further sensor that an object had entered the safety area and what the current situation is. The situation can be assessed particularly well by comparing the images and videos.

Preferably, the safety area has multiple access areas, wherein each access area is monitored by the computer system with at least one camera and at least one further sensor. By monitoring all access areas, equal protection of the safety area is guaranteed.

The further sensor is preferably a light barrier, a contact sensor, an ultrasonic sensor or a radar sensor. The outputs of these types of sensors are particularly easy and quick to evaluate. It can therefore be quickly detected that an object has entered the safety area. The safety area can therefore be secured quickly.

The following description of preferred embodiments serves to explain embodiments of the present disclosure in greater detail with reference to the drawings.

According to an embodiment of the present disclosure, a system is provided, comprising a safety area, in particular a safety area of a machine tool, a camera, a further sensor and a computer system, wherein the safety area has at least one access area and access to the safety area is only possible via the access area, wherein the camera and the further sensor are provided and configured to monitor the access area, wherein the camera and the further sensor are connected to the computer system, wherein the computer system is provided and configured to monitor by means of the further sensor whether an object enters the safety area, wherein the camera is provided and configured to capture at least one image of the access area when the computer system detects by means of the further sensor that an object is entering the safety area, wherein the computer system is provided and configured to evaluate the image recorded by the camera only after it has been established by means of the further sensor that an object has entered the safety area. In other words, the system is provided and configured to carry out a method according to the present disclosure.

Particularly preferably, the system is provided and configured to carry out a method according to the present disclosure according to an embodiment as described above.

Elements that are the same or have equivalent functions are denoted by the same reference signs in all the exemplary embodiments.

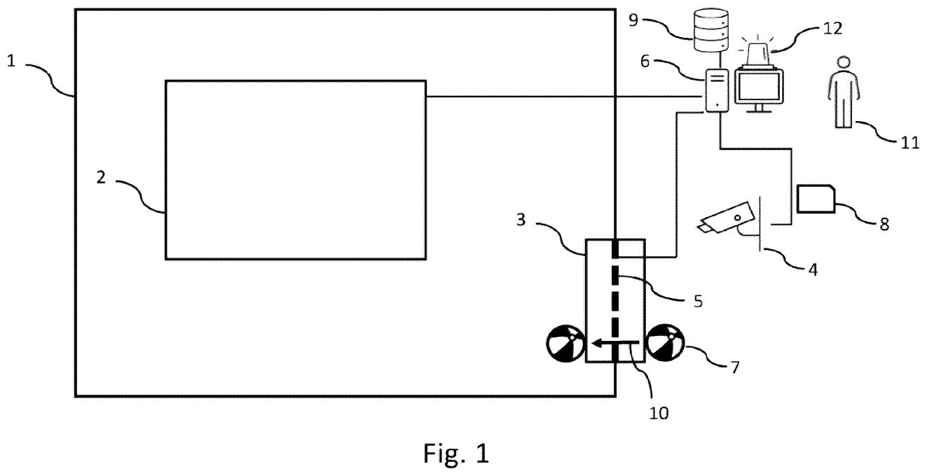

FIG. 1 shows a system comprising a safety area 1. A machine tool 2 is located within the safety area 1. The safety area 1 has an access area 3. Access to the safety area 1 is only possible via the access area 3. In this example, the safety area 1 is protected by a fence with the exception of the access area 3. The access area 3 is monitored by a camera 4 and a further sensor 5, in this case a light barrier. The camera 4 and the further sensor 5 are connected to a computer system 6.

An object 7, in this case a ball, which moves through the access area 3, is detected by the further sensor 5. In this way, the computer system 6 detects by means of the further sensor 5 that the object 7 has entered the safety area 1 and subsequently secures the safety area 1. For this purpose, the computer system 6 is connected to the machine tool 2 and the computer system 6 stops the machine tool 2.

The camera 4 generates an image 8 at regular intervals. These images 8 are stored in a memory 9 in the form of a video stream. The memory 9 is used as a ring memory. Its use as a ring memory means that a video stream of a fixed length, in this case ten seconds, is permanently stored. Newly received images 8 or parts of the video stream overwrite the oldest images 8 or parts of the video stream in the memory 9.

After the computer system 6 has established by means of the further sensor 5 that the object 7 has entered the safety area 1, the computer system 6 evaluates the images 8 generated by the camera 4 and stored in the memory 9. Algorithms for image processing are provided in the computer system 6 for this purpose. The algorithms can be used, for example, to determine the direction of movement 10 of the object 7. The algorithms can also be used to determine the type of object, for example. The algorithms can contain an artificial intelligence, e.g. in the form of a neural network. If the computer system 6 recognizes that there is no hazard in the safety area 1, the computer system 6 releases the safety area 1 and starts the machine tool 2.

If the computer system 6 detects a potential hazard in the safety area 1 or if the computer system 6 cannot unambiguously assess the situation, the computer system 6 shows the images 8 to an operator 11. In order to alert the operator 11 to the potential hazard in the safety area 1, the computer system 6 can output a warning signal 12, in this case a flashing light. The operator 11 can then evaluate the images 8 and either release the safety area 1 or initiate measures to eliminate the hazard.

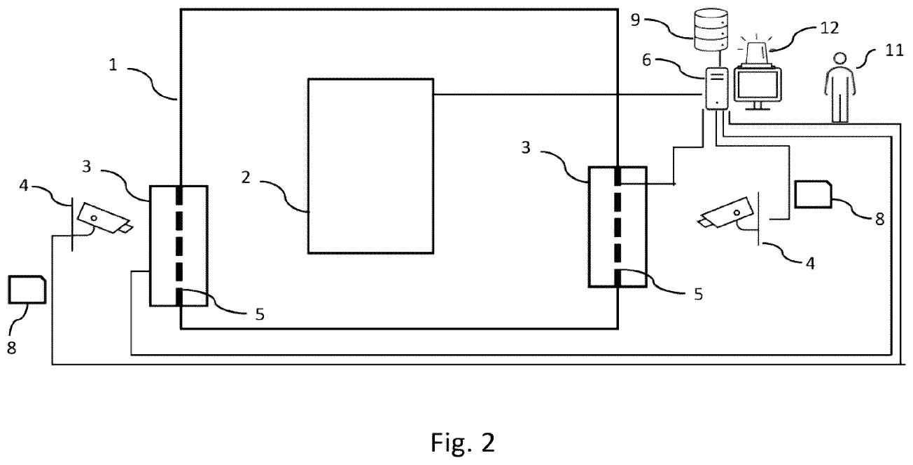

FIG. 2 shows a system with a safety area 1 and two access areas 3. Each access area 3 is monitored by a camera 4 and a further sensor 5. The cameras 4 and the further sensors 5 are each connected to the computer system 6. No object is shown in this example. It is to be understood that when an object enters the safety area 1, the same thing happens as described with respect to FIG. 1, irrespective of the access area 3 through which the object enters the safety area 1.

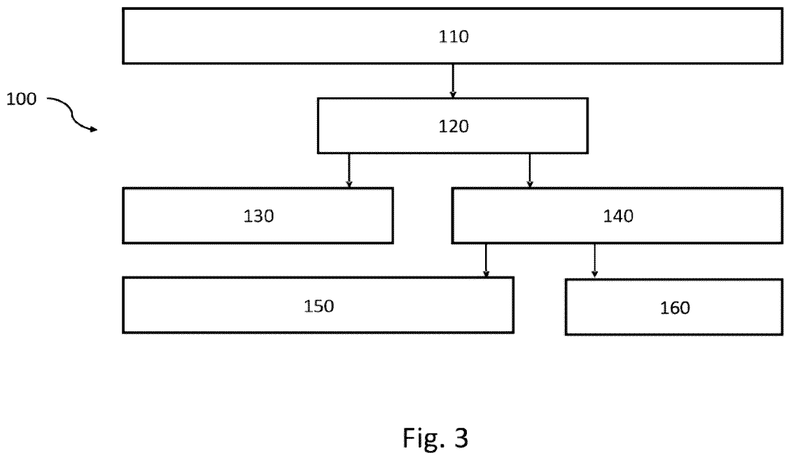

FIG. 3 shows an exemplary method according to the present disclosure. In the first step 110, the computer system 6 uses the further sensor 5 to monitor whether an object 7 enters the safety area 1. As soon as an object 7 is detected with the further sensor 5 in a second step 120, the safety area 1 is secured in a third step 130. For this purpose, the computer system 6 stops the machine tool 2. In a fourth step 140, one or more images 8 from the camera 4 of the time of detecting the object 7 and preferably of the time thereafter are processed by the computer system 6. In this example, the camera 4 generates images 8 at regular intervals, which are stored in a memory 9 and can be loaded from there by the computer system 6. If the computer system 6 recognizes that there is no hazard in the safety area 1, the computer system 6 releases the safety area 1 in a fifth step 150. If the computer system 6 detects a hazard in the safety area 1 or cannot unambiguously assess the situation, an operator 11 is informed by the computer system 6 in a sixth step 160.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Safety area
2 Machine tool
3 Access area
4 Camera
5 Sensor
6 Computer system
7 Object
8 Image
9 Memory
10 Direction of movement
11 Operator
12 Warning signal
100 Method
110 First step
120 Second step
130 Third step
140 Fourth step
150 Fifth step
160 Sixth step

1. A method for monitoring a safety area of a machine tool, wherein the safety area has at least one access area and access to the safety area is only possible via the access area, the method comprising:
monitoring the access area is at least by a camera and a further sensor;
connecting the camera and the further sensor to a computer system;
monitoring with the computer system, by the further sensor, whether an object enters the safety area;
capturing with the camera at least one image of the access area when the computer system detects by the further sensor that the object is entering the safety area; and
evaluating the at least one image captured by the camera with the computer system after it has been established by the further sensor that the object has entered the safety area.

2. The method according to claim 1, further comprising securing the safety area when it has been established by the further sensor that the object has entered the safety area.

3. The method according to claim 1, further comprising repeatedly recording records images with the camera at regular intervals in a form of a video.

4. The method according to claim 1, further comprising storing the at least one image captured by the camera in a ring memory for at least one second.

5. The method according to claim 1, further comprising continuously recording images in regular intervals in a form of a video.

6. The method according to claim 1, wherein the camera only starts to capture the at least one image after it has been established by the further sensor that the object has entered the safety area.

7. The method according to claim 1, wherein the camera, at least after it has been established by the further sensor that the object has entered the safety area, continuously records images.

8. The method according to claim 1, wherein the computer system automatically evaluates the at least one image captured by the camera and automatically releases the safety area based on the evaluation showing that the safety area is secure.

9. The method according to claim 8, wherein the computer system examines multiple successive images of the at least one images for the object, the object being a moving object.

10. The method according to claim 9, wherein the computer system determines a direction of movement of the object, including determining whether the direction of movement of the object is directed into the safety area or out of the safety area.

11. The method according to claim 1, wherein the computer system outputs the at least one image for releasing the safety area by an operator.

12. The method according to claim 11, wherein the computer system outputs to the operator the at least one image a form of a video after it was established by the further sensor that the object has entered the safety area, and outputs to the operator at least one further image comprising a current video transmission, which represents current conditions.

13. The method according to claim 1, wherein the safety area has multiple access areas, and wherein each access area is monitored by the computer system with at least one camera and at least one further sensor.

14. The method according to claim 1, wherein the further sensor is a light barrier, a contact sensor, an ultrasonic sensor or a radar sensor.

15. A system, comprising:
a safety area of a machine tool;
a camera;
a further sensor; and
a computer system,
wherein the safety area has at least one access area and access to the safety area is only possible via the access area,
wherein the camera and the further sensor are configured to monitor the access area,
wherein the camera and the further sensor are connected to the computer system,
wherein the computer system is configured to monitor, by the further sensor, whether an object enters the safety area,
wherein the camera is configured to capture at least one image of the access area when the computer system detects, by the further sensor, that the object is entering the safety area, and
wherein the computer system is configured to evaluate the at least one image captured by the camera only after it has been established by the further sensor that the object has entered the safety area.

16. The method according to claim 4, wherein the at least one images captured by the camera are stored in the ring memory for at least two seconds.

17. The method according to claim 16, wherein the at least one images captured by the camera are stored in the ring memory for at least five seconds.

18. The method according to claim 11, further comprising outputting a warning signal to the operator.
